(19) United States
(12) Patent Application Publication
(10) Pub. No.: US 2023/0105332 A1
(43) Pub. Date: Apr. 6, 2023

(54) HYDRAULIC HEIGHT CONTROL FOR AGRICULTURAL TILLAGE EQUIPMENT

(71) Applicant: Harvest International, Inc., Storm Lake, IA (US)

(72) Inventors: Jeffrey Alan Sivinski, Cherokee, IA (US); Byron James Friesen, Storm Lake, IA (US); Garry D. Friesen, Storm Lake, IA (US); KURT W. OLSEN, NEWELL, IA (US)

(21) Appl. No.: 17/937,147

(22) Filed: Sep. 30, 2022

Related U.S. Application Data
(60) Provisional application No. 63/261,994, filed on Oct. 1, 2021.

(51) Int. Cl. A01B 63/32; A01B 49/02; A01B 73/06

(52) U.S. Cl. CPC A01B 63/32; A01B 49/027; A01B 73/065

(57) ABSTRACT

A hydraulic height control system controls all raising, lowering and folding movement of agricultural tillage equipment. The system includes a single hydraulic circuit utilizing non-rephase cylinders which allows for independent raising and lowering of the equipment frame sections and tool gangs. The hydraulic circuit also controls the folding of the frame wings between field and transport positions. Sensors monitor component positions. The hydraulic circuit also uses a common rail for providing fluid to the cylinders. The system achieves precise depth control in the high speed tilling agricultural environment by keeping the tilling components at the appropriate depth or operating position

### CROSS REFERENCE TO RELATED APPLICATIONS

This application claims priority under 35 U.S.C. § 119 to provisional patent application U.S. Ser. No. 63/261,994, filed Oct. 1, 2021. The provisional patent application is herein incorporated by reference in its entirety, including without limitation, the specification, claims, and abstract, as well as any figures, tables, appendices, or drawings thereof.

### TECHNICAL FIELD

The present disclosure relates generally to agricultural tillage equipment, and more particularly, to a height control system and method to provide simpler and more accurate positioning of the depth of the tillage equipment.

### BACKGROUND

Agricultural tillage systems on the market today utilize manual mechanical adjustments to change the depth and level of the soil-working tools. These adjustments can be done with various devices such as depth stops, crank handles, and pin/hole adjustment. This requires the operator to stop the tilling operation and leave the operator station to make the adjustments. These adjustments are time consuming and inconvenient, which often leads to less frequent, or rare, adjustment and fine tuning of the frame, such as once per season.

Current systems also don't allow for the independent adjustment of the frame sections across the width of the frame. This causes the ground engaging equipment to be uneven across the frame which causes uneven tillage. When a frame raises and lowers unevenly, it can cause the tillage units to operate at different levels in the soil or can cause them to engage the ground unevenly.

Many tillage frames on the market today utilize a master/slave rephasing hydraulic system, for raising and lowering the toolbar frame. Master/slave rephase hydraulic systems utilize oil from the rod end of the master cylinder to supply lift oil to the base end of the slave cylinder system. While this system is widely used, it has many drawbacks, such as uneven raise and lower functions when the toolbar frame cylinders get out of “phase”, reduced efficiency of the hydraulic system, and increased hydraulic oil heat, which can cause cylinder failure and heat-induced hydraulic component failures. When a master/slave hydraulic system gets out of “phase”, meaning not all the cylinders on the planter or tillage frame are extending or retracting to the same position, the cylinders must be either fully raised or fully lowered, and maintained at that position, to force oil around the hydraulic cylinder piston through a very small rephasing port in the hydraulic cylinder, in order to force all of the cylinder pistons into the same position.

Additionally master/slave rephase hydraulic systems require different sizes of hydraulic cylinders, based on volumetric values of the hydraulic cylinder rod and base oil capacities, to be used across the width of the toolbar. Master/slave cylinder systems also require dedicated and specific hydraulic supply hose routing to maintain the proper flow of oil to consecutive hydraulic cylinders used in the series.

Precise depth control is paramount in the high speed tilling agricultural environment. Keeping the tilling components at the appropriate depth or operating position has created challenges for conventional master/slave hydraulic systems.

Accordingly, a primary objective of the present invention is the provision of an improved hydraulic system for agricultural tillage equipment.

Another objective of the present invention is the provision of a hydraulic system using non-rephased cylinders to control the height of tillage equipment.

Still another objective of the present invention is the provision of a single hydraulic circuit to control all raising, lowering and folding movements of agricultural tillage equipment.

A further objective of the present invention is the provision of a hydraulic height control system for tillage equipment which is responsive to signals from position sensors on the hydraulic cylinders or on the tillage frame sections.

Yet another objective of the present invention is provisional of a hydraulic system on a frame that utilizes the same size cylinders across the width of the frame to raise and lower the ground equipment.

Another objective of the present invention is the provision of a hydraulic height control system for agricultural tillage equipment with simplifies adjustment of the equipment height.

A further objective of the present invention is the provision of a hydraulic system for agricultural tillage equipment with permits independent adjustment of the height of different frame sections.

Another objective of the present invention is the provision an agricultural tillage front and rear tool gangs which can be raised and lowered independently of one another.

Still another objective of the present invention is the provision of a hydraulic height adjustment assembly for agricultural tillage equipment that maintains even engagement of the equipment with the ground.

A further objective of the present invention is the provision of a hydraulic system on agricultural tillage equipment which uses a single hydraulic circuit with a common rail to supply hydraulic fluid to all the hydraulic cylinders in the system.

Another objective of the present invention is an improved hydraulic system for an agricultural toolbar which produces optimal depth for planting and fertilization by accurately controlling the operating height of the toolbar and components mounted on the toolbar.

These and other objectives will become apparent from the following description of the invention.

### SUMMARY

The hydraulic system for controlling tillage equipment height eliminates the use of manual mechanical adjustment, rephase hydraulic cylinders and the coinciding hydraulic hose routing of the prior art systems, by replacing the rephrase cylinders with non-rephase cylinders throughout the toolbar frame, and implementing a single hydraulic circuit that utilizes a common rail or common main tube hydraulic system that supplies oil to all of the hydraulic components on the frame.

A computer console mounted in the tractor cab controls the oil flow supply to the hydraulic cylinders via hydraulic valves and data received from the position sensors to control the heights of the tillage equipment, so as to maintain a uniform tilling depth. All the various equipment sections are controlled independently. This, for example, allows for independent adjustment of the finishing rollers and the wheels, as well as independent control of each section side to side, and the folding and unfolding between field and use positions.

Features of the system include the following: allow the frame to maintain even raise and lower functions as controlled by the computer console, the ability of the operator to bias any section of the frame up or down manually, and to accommodate differing soil conditions or tilling preferences. These functions are accomplished via a screen selection key button and rotary adjustment knob on the computer console. Manual control can optionally be replaced by either a physical position measuring tool such as floating ground engaging wheel, ultrasonic measuring or radar driven measuring systems, to automatically adjust the frame raise/lower hydraulic cylinders to maintain the desired height distance from the soil surface.

Additionally, the system allows for the operator to either manually adjust or automatically set the desired downforce on the wings.

This hydraulic system is more efficient, allows for less fuel consumption to power hydraulic components, reduces heat in the system, and reduces wear of frame lifting components.

This hydraulic system is very adaptable to many different hydraulically controlled features and options, without sacrificing the primary purpose of the system, which is accurately control the operating height of the toolbar, to achieve optimal planting depth of modern precision seed and fertilizer application systems.

These and/or other objects, features, and advantages of the disclosure will be apparent to those skilled in the art. The present invention is not to be limited to or by these obj ects, features and advantages. No single embodiment need provide each and every object, feature, or advantage.

### BRIEF DESCRIPTION OF THE DRAWINGS

FIG. 1 is a perspective view of agricultural tillage equipment having a toolbar or frame with front and rear tool gangs and roller baskets in a field position, and with the hydraulic system of the present invention, wherein the wheel cylinders are retracted and the roller basket cylinders are extended, so that the front tool gang is raised relative to the rear tool gang, and wherein the frame cylinders are extended and the wing cylinders are extended.

FIG. 2 is a perspective view of the tillage equipment in the field position, wherein the wheel cylinders are extended, and the roller basket cylinders are extended, so that the front tool gang is lowered relative to the rear tool gang, and the frame and wing cylinders are extended.

FIG. 3 is a perspective view of the tillage equipment, wherein the frame cylinders are retracted to move the frame from the field position to a raised intermediate position, as a first step towards the transport position.

FIG. 4 is a perspective view of the tillage equipment wherein the wing cylinders are retracted to fold the wings to the raised transport position.

FIG. 5 is a top plan view of the tillage equipment assembly showing the single hydraulic circuit of the present invention.

FIG. 6 is a hydraulic schematic of the hydraulic circuit of the invention.

FIG. 7 is an enlarged perspective view of one of the wheels and wheel cylinders, with a position sensor on the wheel cylinder.

FIG. 8 is a perspective view of the wheel cylinder and position sensor.

FIG. 9 is a plan view of the wheel cylinder and position sensor.

FIG. 10 is an enlarged view showing an alternative placement of a position sensor on a wheel arm, according to the present invention.

### DETAILED DESCRIPTION

This application incorporates by reference Applicant's pending patent application Ser. No. 16/543,202 filed on Aug. 8, 2019, and entitled Toolbar With Hydraulic Height Control, in its entirety.

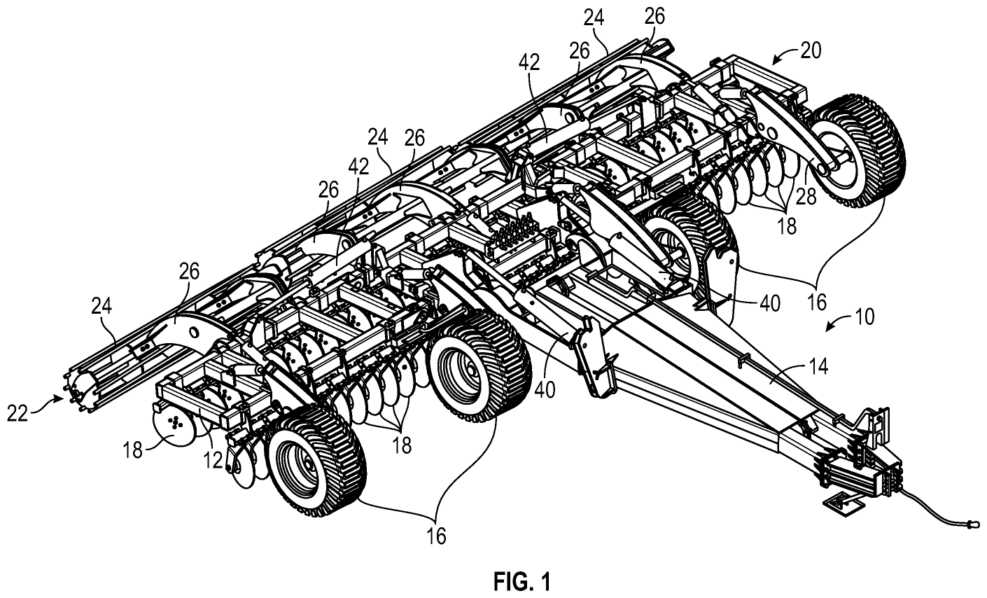

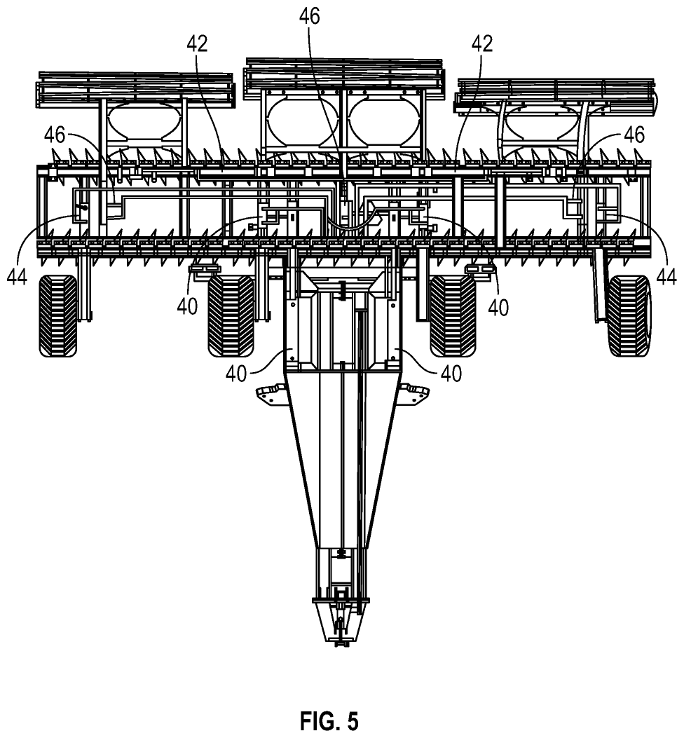

An agricultural tillage assembly 10 is shown in FIGS. 1-5. The tillage assembly 10 includes a laterally extending frame 12 having a tongue 14 adapted to be hitched to a tractor or other tow vehicle. The frame 12 and tongue 14 are supported by a plurality of wheels 16. The frame 12 supports one or more rows of tool gangs, with each gang having a plurality of soil-working and/or firming tools, such as discs 18. For example, as seen in the drawings, the frame 16 and discs 18 form a front tool gang 20, and a rear tool gang 22 extends behind the front tool gang 20. The rear tool gang 22 may include various soil working tools, such as the rollers, rolling wheels, rolling rings, or rolling baskets 24 which provides finishing conditioning to the soil. The rear or finishing gang 22 is supported by a plurality of arms 26 pivotally mounted to the frame 12.

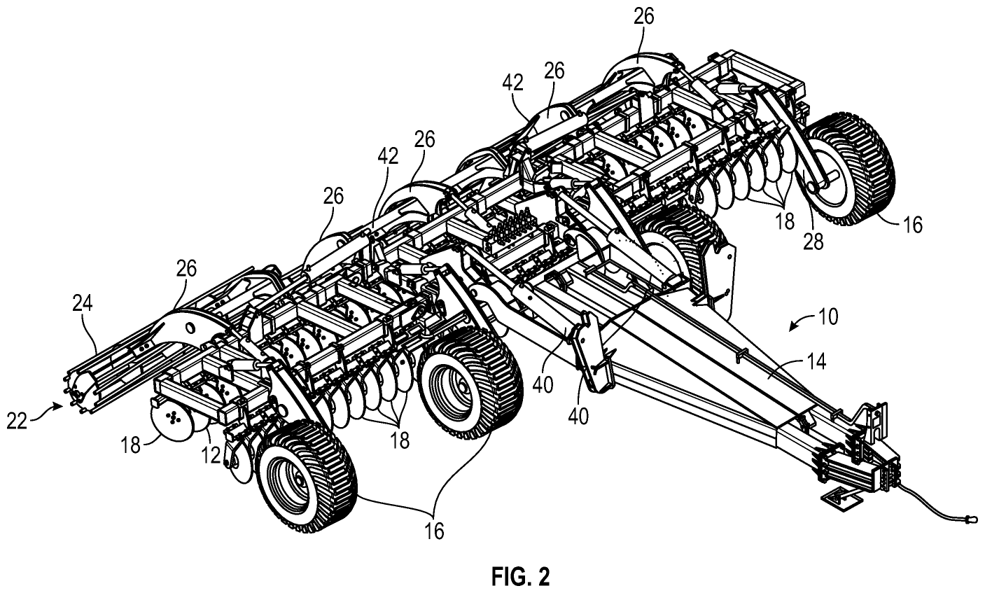

Each of the wheels 16 is pivotally mounted to the frame 12 via an arm 28 for movement about a horizontal, laterally extending axis between a raised position (FIG. 1) and a lowered position (FIG. 2). Each of the roller baskets 24 are pivotally mounted to the frame 12 by a pair of arms 30 for movement about a horizontal, laterally extending pivot axis between a lowered field position and a raised transport position.

The frame 12 also includes a center section 32 and left and right wings 34, 36.

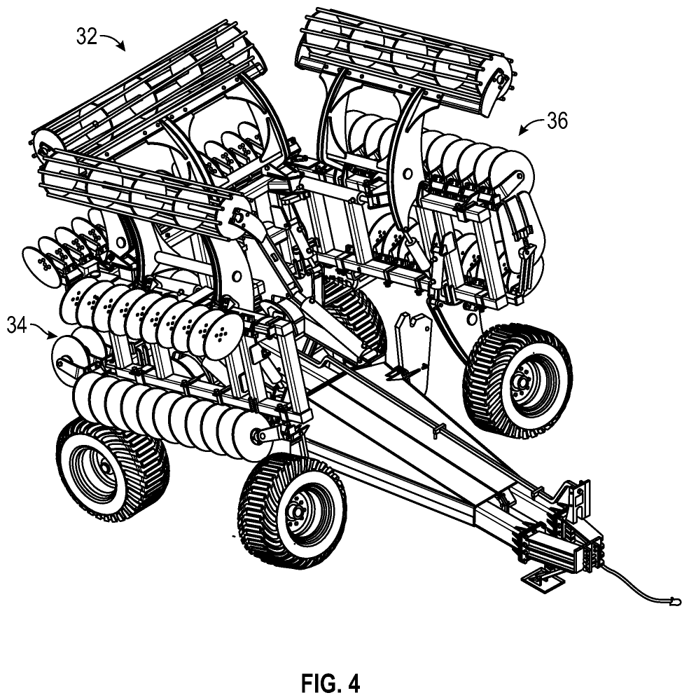

The wings 34, 36 are pivotally connected to the center section 32 for movement about a horizontal, longitudinally extending pivot axis between a lowered use position (FIGS. 1-2) and a raised transport position (FIG. 4).

The height of the front and rear tool gang 20, 22, and the folding of the wings 34, 36 is controlled by a single hydraulic circuit having a plurality of non-rephased cylinders. More particularly, the hydraulic system includes a first pair of cylinders 40 connected to the center section 32 to raise and lower the center section between the field and transport positions. A second pair of laterally extending cylinders 42 are connected to the wings 34, 36 to fold and unfold the wings between the transport and field positions. A plurality of cylinders 44 are also operatively connected on each of the wheel arms 28 to raise and lower the wheels in the field position. Lastly, a plurality of cylinders 46 are operatively connected to each of the roller baskets (or other tool on the rear gang 22) to raise and lower the roller baskets in the field position.

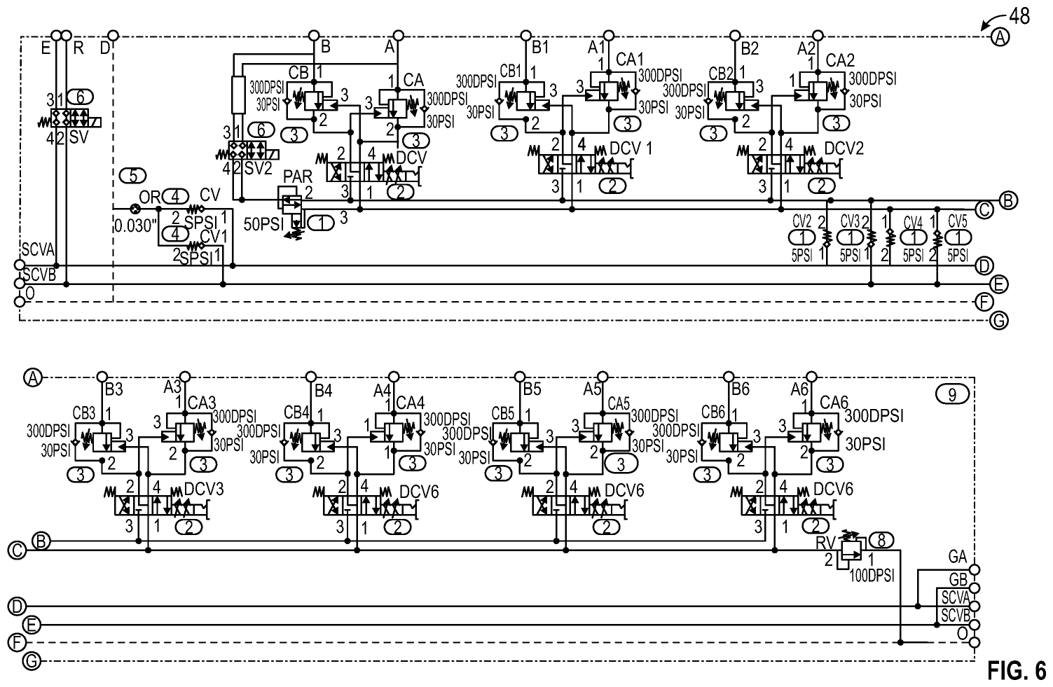

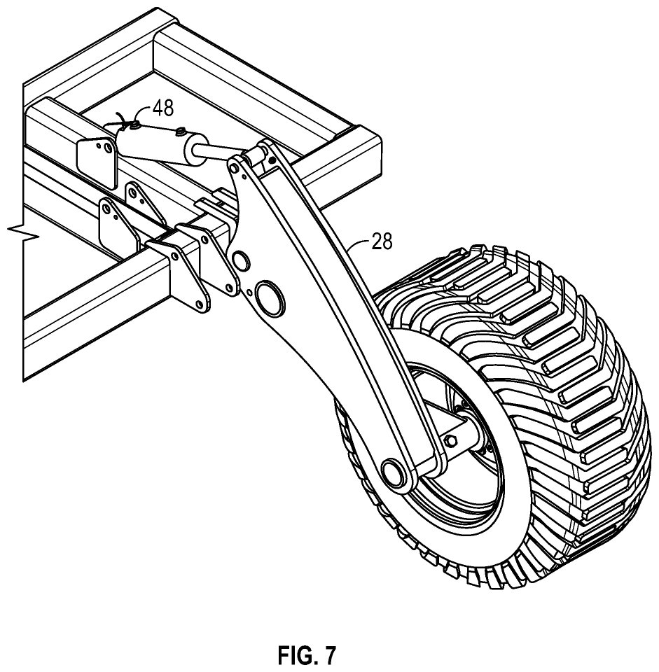

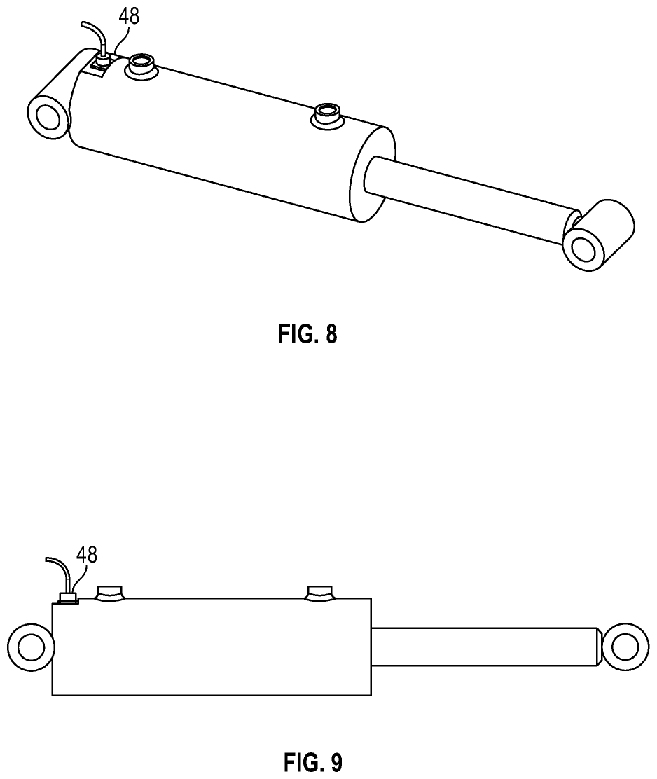

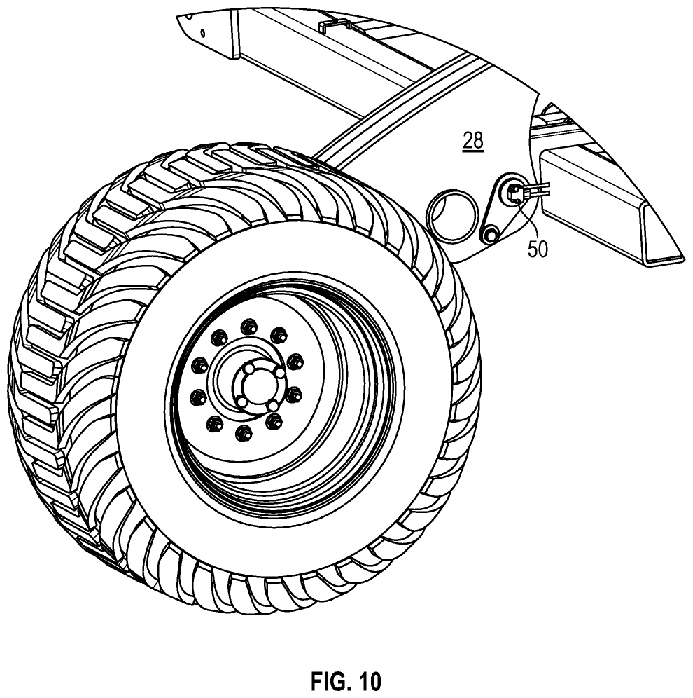

All of the cylinders 40, 42, 44, and 46 are a part of a single hydraulic circuit, which includes conventional check valves, control valves, counter balance valves, pressure reducing valves, and relief valves, all contained in a manifold 48, as shown in FIG. 6. All of the cylinders 40, 42, 44 and 46 are non-rephase cylinders. The hydraulic system utilizes position sensors 48 on the cylinders 40, 42, 44, and 46, as shown in FIGS. 7-9. Alternatively, a position sensor 50 can be mounted on each wheel support arm 28, as shown in FIG. 10 and as described in co-pending U.S. application Ser. No. 16/543,202.

The hydraulic circuit and actuation of the cylinders is controlled in the same way as described in Applicant's co-pending U.S. application Ser. No. 16/543,202, via a computer control console mounted in a tractor cab. The operator can control the oil flow supply to the hydraulic cylinder via the hydraulic valves and data received from the position sensors 48, 50 in order to maintain uniform tilling depth of the soil. The control console also identifies or tracks the oil flow direction to and from the cylinders, as described in co-pending U.S. application Ser. No. 16/543,202.

The height of the front and rear tool gangs 20, 22 can be independently controlled through the hydraulic circuit of the present invention, for controlling the depth of the tillage equipment in the field. For example, as shown in FIG. 1, the wheel cylinders 44 can be retracted to raise the wheels 16 and thus lower the discs 18 relative to the rolling baskets 24. As shown in FIG. 2, the wheel cylinders 44 can be extended, so as to lower the wheels 16 and raise the discs 18. As further seen in FIG. 2, the rolling basket cylinders 46 are extended such that the rolling baskets 24 are lowered relative to the discs 18. When the cylinders 46 are retracted, the rolling baskets 24 are raised relative to the discs 18.

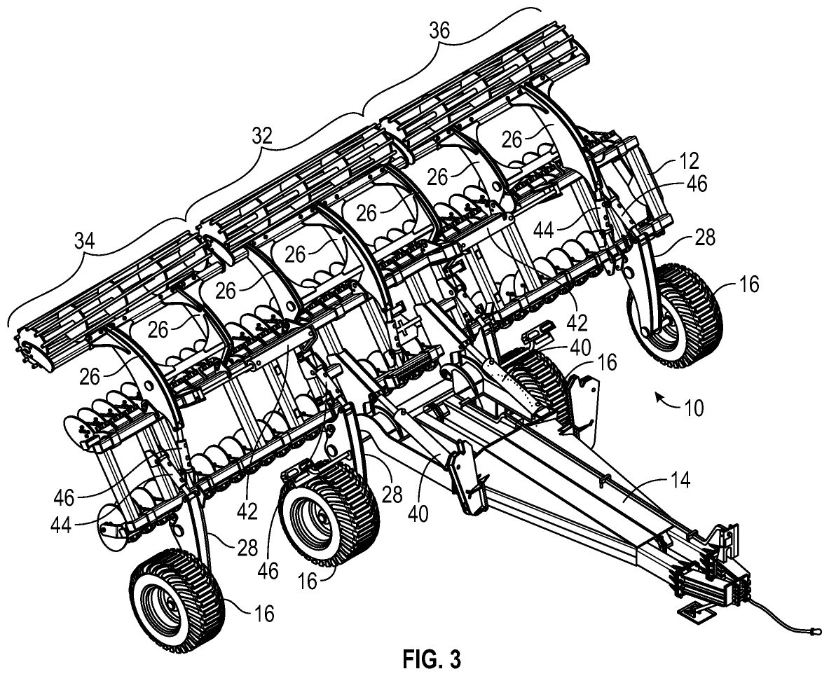

When it is desired to move from the field position shown in FIGS. 1 and 2 wherein the main cylinders 40 are extended, the main cylinders 40 are retracted as shown in FIG. 3, to initiate a first folding step for the front and rear gangs 20, 22. Then, in a second folding step, the wing cylinders 44 are actuated from the extended field position to the retracted transport position, shown in FIG. 4, so as to fold the wings 34, 36, upwardly to the transport position.

The hydraulic system of the present invention can provide additional functionality. For example, the system can independently control the downforce on each wing and may.

independently control the downforce on the finishing gang. The system can also detect via a sensor that rotary tillage tools are not turning and notify the operator. Furthermore, the system can hydraulically adjust blade or disc offset from tractor cab between the gangs and can hydraulically change the blade angle from the tractor cab.

Thus, the single hydraulic circuit with non-rephase cylinders accomplishes all of the objectives of the present invention.

What is claimed is:

1. An agricultural tillage assembly, comprising:
a frame;
wheels on the frame for supporting the frame above the ground;
a front tool gang on the frame;
a rear tool gang on the frame;
a hydraulic system with a single circuit for independently controlling heights of the front and rear tool gangs.

2. The tillage assembly of claim 1 wherein the hydraulic system includes a plurality of non-rephase cylinders and a hydraulic rail that supplies oil to all of the non-rephase cylinders,

3. The tillage assembly of claim 2 further comprising a position sensor associated with each of the cylinders, and wherein the height of the gangs is adjusted based on a signal from the sensors.

4. The tillage assembly of claim 1 wherein the front tool gang includes discs, and the rear tool gang includes soil tools.

5. The tillage assembly of claim 1 wherein each gang includes a center section and left and right wings, and the hydraulic system allows selective movement of the center section and wings either independently of one another, and alternatively movement of all the sections and wings in unison with one another.

6. The tillage assembly of claim 5 further comprising position sensors associated with the center section and wings, and wherein the height of the gangs is adjusted based on signals from the sensors.

7. The tillage assembly of claim 1 wherein the hydraulic system moves the gangs between a field position and a transport position.

8. The tillage assembly of claim 1, further comprising a control system operatively connected to the hydraulic system, and a human machine interface (HMI) in communication with the control system.

9. The tillage assembly of claim 1 wherein the frame folds between transport and field positions, and the hydraulic circuit controls the folding of the frame.

10. A method of controlling heights of an agricultural tillage assembly having front and rear tool gangs, comprising:
providing oil flow through non-rephase cylinders in a single hydraulic circuit connected to the front and rear tool gangs to raise and lower the gangs independently of one another.

11. The method of claim 10 further comprising determining oil flow direction through the hydraulic system to maintain accurate operating height of the gangs.

12. The method of claim 10 further comprising actuating the cylinders in response to signals from position sensors on the cylinders or on the tool gangs.

13. The method of claim 10 wherein the oil is provided to the cylinders via a common rail.

14. The method of claim 10 further comprising controlling a position of the gangs with a human machine interface (HMI) in communication with a control system operatively connected to the cylinders.

15. The method of claim 10, wherein each of the front and rear tool gangs includes a center section and left and right wings, and the method further comprising folding the wings between raised and lowered transport and field positions with the single hydraulic circuit.

16. An agricultural tillage assembly, comprising:
a frame with a center section and opposite left and right wings extending from opposite ends of the center section;
the wings being movable between field and transport positions;
front and rear tool gangs on forward and rearward sides of the frame, respectively;
the center section and wings being movable vertically to raise and lower the tool gangs; and
a single hydraulic circuit with a plurality of cylinders operatively connected to the frame to independently raise and lower the front and rear tool gangs and to move the wings between the field and transport positions.

17. The tillage assembly of claim 16 wherein the cylinders are non-rephase cylinders.

18. The tillage assembly of claim 16 wherein the hydraulic circuit has a common rail for providing hydraulic fluid to the cylinders.

19. The tillage assembly of claim 16 further comprising control sensors to monitor the height of positions of the tool gangs and to send signals to adjust the cylinders.

20. The tillage assembly of claim 16 sensors to monitor extension and retraction of the cylinders.
